(19) United States
(12) Patent Application Publication
(10) Pub. No.: US 2010/0033499 A1
(43) Pub. Date: Feb. 11, 2010

(54) System and method for eliminating confusion between weather data and terrain data in aircraft displays

(75) Inventors: Aaron J. Gannon, Anthem, AZ (US); Shephen G. McCauley, Peoria, AZ (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., MORRISTOWN, NJ (US)

(21) Appl. No.: 11/089,727

(22) Filed: Mar. 25, 2005

(51) Int. Cl. G09G 5/00; G01S 13/95

(52) U.S. Cl. 345/629; 342/26 R

(57) ABSTRACT

An improved system and method are disclosed for eliminating pilot confusion in visualizing multiple categories of data, such as, for example, weather data and terrain data, simultaneously on an integrated, multi-color display. For example, an aircraft display system is disclosed that includes a processing unit, a terrain database, a weather data source, a visual display for displaying multi-color weather data and terrain data, and a control device for controlling the duration of the weather data being shown on the visual display. As an aircraft proceeds along a flight path, the processing unit retrieves and/or receives weather data from the weather data source and terrain data from the terrain database. The processing unit provides color renderings of the terrain data to the visual display. The processing unit determines a time duration for the weather data from a setting of the control device (e.g., set by a pilot), and provides color renderings of the weather data to the visual display for the selected time duration. For example, the weather data sweep on the display can become narrower or wider depending on the time duration selected. Also, for example, the trailing edge of the weather data sweep can become more transparent and/or opaque as the sweep becomes narrower. Thus, the pilot is allowed to control the length of time that the weather data is being displayed, which reduces and/or eliminates confusion in visualizing the terrain data and weather data being displayed simultaneously on the integrated, multi-color display.

### FIELD OF THE INVENTION

The invention relates generally to the field of display systems, and more specifically, but not exclusively, to a system and method for eliminating confusion between weather data and terrain data in aircraft displays.

### BACKGROUND OF THE INVENTION

Aircraft displays have become highly sophisticated and are capable of displaying a substantial amount of information, such as, for example, weather information and terrain information. The weather information shown on an aircraft's display is typically airborne weather information depicting adverse weather conditions, such as, for example, clouds, rain, ice or snow storms, thunderstorms, clear air turbulence, wind shear, microbursts, etc. Such weather information may be received from an onboard weather radar system and/or one or more external ground-based or satellite-based weather information sources. The terrain information shown on an aircraft's display is typically situational awareness terrain information, and terrain caution and warning information (e.g., Enhanced Ground Proximity Warning System or EGPWS data), which can identify for a flight crew potential terrain threat information (e.g., potential for impact, collision, etc.). As such, the displayed weather and terrain information allows a pilot to alter an aircraft's flight path and avoid the adverse weather conditions and/or the potential terrain threat(s) identified. Therefore, it is highly desirable to enable flight crews to visualize weather and terrain information on a single display. An example of such a display is disclosed in commonly assigned U.S. Pat. No. 6,653,947 B2 to Dwyer et al. (“Dwyer”), which is incorporated herein by reference in its entirety. Dwyer discloses a single display, which is used to display weather data on one portion of the display screen and terrain data on a second portion of the screen. The weather data is typically displayed as a two-dimensional graphic, and the terrain data is typically displayed as a three-dimensional graphic.

Notwithstanding the significant advantages of the aircraft display disclosed in Dwyer, a significant drawback of existing aircraft displays is that pilots can be confused by the separation of the weather data and terrain data on a display screen. Also, in order to enhance the rapid recognition of the particular weather data and terrain data being viewed, these different categories of data are typically color coded on a multi-color display. However, a significant problem with such multi-color displays is that some of the same color codes are used for data in the different data categories being displayed. Consequently, pilots can be confused by either the separation of the weather data and terrain data on the existing displays, or the use of identical color codes for some of the data in the different data categories being displayed (e.g., weather data and terrain data). This problem of confusion increases the potential for unsafe flight conditions. Therefore, it is highly desirable to provide a system and method that can eliminate pilot confusion in visualizing weather data and terrain data simultaneously on a multi-colored, integrated display. As described in detail below, the present invention provides such a system and method.

### SUMMARY OF THE INVENTION

The present invention provides an improved system and method for eliminating pilot confusion in visualizing multiple categories of data, such as, for example, weather data and terrain data, simultaneously on an integrated, multi-color display. In accordance with a preferred embodiment of the present invention, an aircraft display system is provided that includes a processing unit, a terrain database, a weather data source, a visual display for displaying multi-color weather data and terrain data, and a control device for controlling the duration of the weather data being shown on the visual display. For this example embodiment, as an aircraft proceeds along a flight path, the processing unit retrieves and/or receives weather data from the weather data source and terrain data from the terrain database. The processing unit provides color renderings of the terrain data to the visual display. The processing unit determines a time duration for the weather data from a setting of the control device (e.g., set by a pilot), and provides color renderings of the weather data to the visual display for the selected time duration. For example, the weather data sweep on the display can become narrower or wider depending on the time duration selected. Also, for example, the trailing edge of the weather data sweep can become more transparent and/or opaque as the sweep becomes narrower. Thus, the present invention allows a pilot to control the length of time that the weather data is being displayed, which reduces and/or eliminates confusion in visualizing the terrain data and weather data being displayed simultaneously on the integrated, multi-color display.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of an example system for eliminating confusion in visualizing multiple categories of data simultaneously on an integrated, multi-color aircraft display, which can be used to implement a preferred embodiment of the present invention;

FIGS. 2A-2C are related pictorial representations depicting visual displays that illustrate one or more exemplary embodiments of the present invention; and

FIG. 3 depicts a flow chart showing an exemplary method for eliminating pilot confusion resulting from a simultaneous showing of terrain data and weather data on an integrated, multi-color aircraft display, in accordance with one or more embodiments of the present invention.

### DETAILED DESCRIPTION OF PREFERRED EMBODIMENT

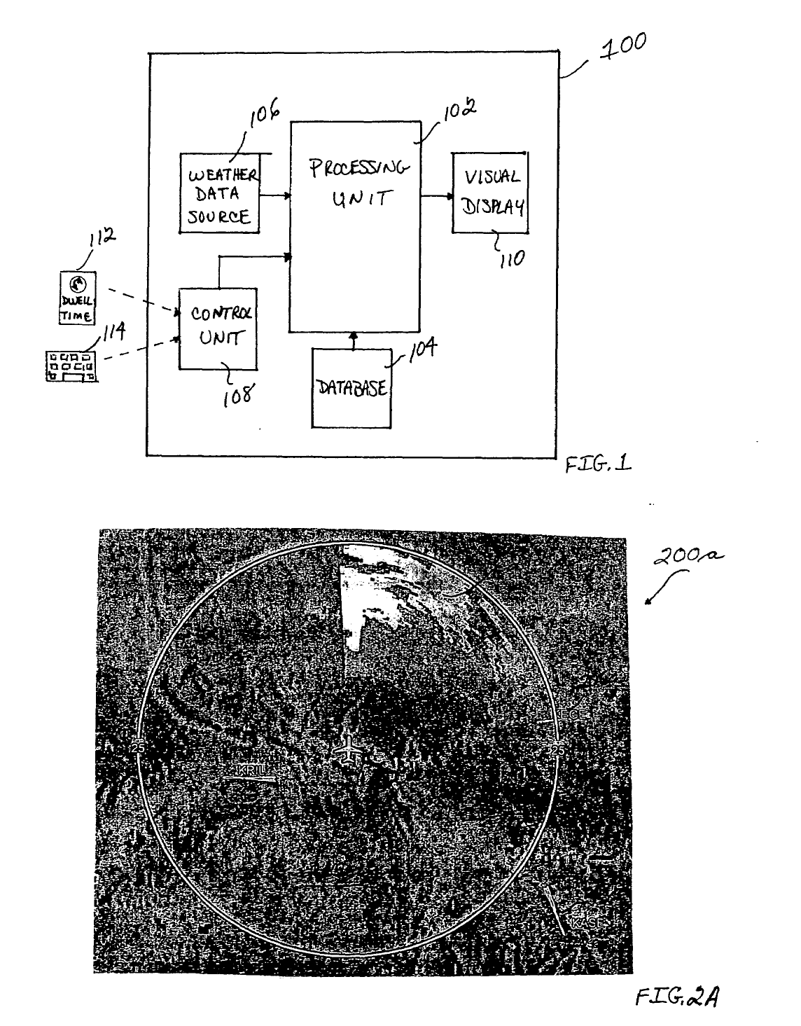

With reference now to the figures, FIG. 1 depicts a block diagram of an example system 100 for eliminating confusion in visualizing multiple categories of data simultaneously on an integrated, multi-color aircraft display, which can be used to implement a preferred embodiment of the present invention. For this example, system 100 includes a processing unit 102, a database 104, a weather data source 106, a control unit 108, and a visual display 110. Notably, it should be understood that although system 100 appears in FIG. 1 to be arranged as an integrated system, the present invention is not intended to be so limited and can also include an arrangement whereby one or more of processing unit 102, database 104, weather data source 106, control unit 108 and visual display 110 is a separate component or a subcomponent of another system located either onboard or external to an aircraft. Also, for example, system 100 can be arranged as an integrated system (e.g., aircraft display system, etc.) or a subsystem of a more comprehensive aircraft system (e.g., navigational system, terrain awareness and/or avoidance system, weather awareness and/or avoidance system, collision alert and/or avoidance system, etc.).

For this embodiment, processing unit 102 can be a computer processor such as, for example, a microprocessor, digital signal processor, or any suitable processor capable of at least receiving and/or retrieving terrain data, weather data, controlling a time duration of the weather data for display, generating display control signals for a multi-color visual display of the terrain data and time duration-controlled weather data, and sending the generated display control signals to a visual display (e.g., visual display 110 in FIG. 1). For example, processing unit 102 can be arranged as a single processor or plurality of processors connected to a data communications bus or system bus. A memory controller/cache can also be connected to the data communications bus or system bus, which can provide an interface between processing unit 102 and a local memory (e.g., RAM, ROM, etc.). A plurality of machine instructions can be stored in the local memory and retrieved and operated on by processing unit 102 to generate the control signals for the visual display. An Input/Output (I/O) bus bridge can also be connected to the data communications bus or system bus, which can provide an interface between processing unit 102 and an I/O bus. Thus, processing unit 102 can receive, retrieve and/or send data via such an I/O bus. In any event, those of ordinary skill in the art will appreciate that the hardware described herein for processing unit 102 in FIG. 1 may vary. As such, the depicted example is provided for illustrative purposes and not meant to imply architectural limitations with respect to the present invention.

For this example embodiment, system 100 also includes a database 104 coupled to processing unit 102 (e.g., via an I/O bus connection). For example, database 104 can be a memory device (e.g., non-volatile memory, disk, drive, tape, mass storage device, etc.) that can store digital terrain data as a function of aircraft position (e.g., latitudinal and longitudinal position data). A source for the digital terrain data stored in database 104 can be, for example, a United States Geological Survey (USGS) map having a resolution of approximately 90 meters, which includes topographical relief information that can be used to apply grid lines following the contour of the terrain. As such, database 104 can store a terrain database including the locations and elevations of natural terrain obstacles such as mountains or other elevated ground areas, and also the locations and elevations of man-made obstacles such as radio antenna towers, buildings, bridges, etc. The terrain database stored in database 104 can also include, for example, the boundaries of restricted airspace, restricted elevations for particular airspace, airport, airway and air park locations, bodies of water, etc. As yet another example, the terrain database stored in database 104 can be a Jeppesen-styled database, which can cover a 300 by 270 mile area of terrain and include topographical relief information. As still another example, the terrain data stored in database 104 can be received from an onboard device that senses and/or maps variations in terrain, such as, for example, a Forward Looking Infrared (FLIR) sensor, or an active or passive type of radar device.

Preferably, the terrain data stored in database 104 includes relevant absolute terrain data and relative terrain data (e.g., aircraft-relative terrain data). Typically, terrain data is color coded to identify a terrain threat For example, an area of terrain that is located well below the current altitude of an aircraft may be shown on a color display as a green (safe) area. A yellow colored (caution) area of terrain displayed may represent a terrain elevation of approximately 2000 feet below the altitude of the aircraft and up to the current altitude of the aircraft. Terrain elevation at the altitude of the aircraft and higher may be displayed as a red colored (warning) area. In any event, any suitable terrain database that can be stored in database 104 may be used to implement the present invention, such as, for example, the terrain database associated with Honeywell International Inc.'s Enhanced Ground Proximity Warning System (EGPWS).

For this embodiment, system 100 also includes a weather data source 106 coupled to processing unit 102 (e.g., via an I/O bus connection). For example, weather data source 106 can be an onboard weather radar system, and/or a component (e.g., receiving unit) of an external weather data source such as a ground-based weather data system (e.g., weather data up-linked from a weather database), or a satellite-based weather data system. As another example, weather data source 106 can include a device that can sense variations in weather conditions, such as, for example, a FLIR or similar active or passive weather sensor. In any event, weather data source 106 can provide for display such weather information as the location of weather cells. This weather information can include, for example, the location of precipitation, which can be displayed in various colors depending on the precipitation intensity of the weather cell(s) involved. The weather data can be color coded to facilitate rapid identification of a weather-related threat. For example, a storm cell area may be colored yellow (e.g., indicating medium intensity precipitation) on a color display, and a more severe storm cell threat may be colored red or magenta (e.g., indicating highest intensity precipitation). A storm cell area may be colored green to indicate that the storm cell is the lowest intensity precipitation. Notably, it should be understood that any suitable source that can provide weather data, which can be visualized by a pilot and represent (e.g., by use of color variances) the intensity or severity of weather conditions associated with an aircraft and its position, may be used to implement weather data source 106.

Also, for this embodiment, system 100 includes a control unit 108 coupled to processing unit 102 (e.g., via an I/O bus connection). For example, control unit 108 can include a rotatable knob (e.g., as denoted by element 112 in FIG. 1) or similar manually operated device coupled to an electronic circuit (not shown), which senses the position of the device (e.g., knob) and translates that position information into a duration of time (e.g., a one-half rotation of the knob may translate to 50% of a predetermined duration of time, a one-quarter rotation of the knob may translate to 25% of the predetermined duration of time, etc.). For definitive purposes, but not intended as a limitation on the scope of the present invention, the terminology “dwell time” is intended to mean the duration of time that weather radar data is to be displayed (e.g., persistence) for one sweep. For example, this manual device (e.g., knob) can be directly accessible to the pilot or other flight crew member. As another option, control unit 108 may include a keypad (e.g., as denoted by element 114 in FIG. 1), which provides keyed in data (e.g., keyed in by a plot or flight crew member) to processing unit 102, which in turn, can translate the keyed in data (e.g., weather radar dwell time=50%) to a duration of time (e.g., 50% of the predetermined duration of time). As yet another option, control unit 108 may be implemented partially (or completely) in software and include a suitable software algorithm executed by processing unit 102, which can generate, for example, an appropriate weather radar dwell time responsive to certain predefined input terrain data and weather data conditions (e.g., generate a weather radar dwell time=50% if a predefined or threshold level of terrain data is retrieved, and/or a predefined or threshold level of weather data is received, etc.).

For this example embodiment, the predetermined duration of time (e.g., weather radar dwell time) may represent the total time it takes for a weather radar system antenna to complete one sweep, or (in other words) the time it takes to paint one sweep of weather data on a visual display. Thus, in accordance with the principles of the present invention, a flight crew member (e.g., pilot) can manipulate (e.g., rotate) a device associated with control unit 108 to determine (e.g., by control unit 108 and/or processing unit 102) a dwell time or time duration for the received weather data to be displayed, or software can be used (e.g., by control unit 108 and/or processing unit 102) to automatically determine such a dwell time or time duration for the received weather data to be displayed. For example, the dwell time may be selected so that the weather radar information is painted on the display so as to persist for a complete sweep if the knob is rotated to one mechanical limit (e.g., 100% dwell time), and the weather radar information being displayed is painted to persist for a smaller duration as the knob is rotated towards the other limit. As an option, but not intended as a limitation imposed on the present invention, the trailing edge of the weather radar information can be painted to appear to progressively fade from opaque to transparent (or, as another option, become more and more translucent) as the rotated knob reaches this other limit (e.g., is turned all the way down, for substantially 0% weather radar dwell time).

For this embodiment, system 100 also includes a visual display 110 coupled to processing unit 102 (e.g., via an I/O bus connection). For example, visual display 110 may include any display element suitable for displaying various types of symbols and information representing weather data and terrain data in an integrated, multi-color form. Using weather data retrieved (or received) from weather data source 106, and terrain data from database 104, processing unit 102 executes one or more algorithms for generating a plurality of display control signals. Processing unit 102 sends the plurality of display control signals to visual display 110. Preferably, for this embodiment, visual display 110 is an aircraft cockpit, multi-color display. Visual display 110 interprets the received plurality of display control signals and generates suitable weather symbology and terrain symbology, which are presented on a screen or monitor of visual display 110. Notably, although a conventional cockpit display screen may be used to display the weather data and terrain data, the present invention is not intended to be so limited and can include any suitable type of display medium capable of visually presenting multi-colored weather data and terrain data for a pilot or flight crew member. As such, many known display monitors are suitable for displaying such weather and terrain information, such as, for example, various CRT and flat-panel display systems (e.g., CRT displays, LCDs, OLED displays, plasma displays, projection displays, heads-up displays, heads-down displays, etc.). For example, visual display 110 can display terrain situational awareness information for a pilot as a 3-dimensional graphic, and the weather information can be displayed as a 2-dimensional graphic.

For this example embodiment, visual display 110 may include a conventional graphics processor (not shown), which can be configured to provide terrain data and weather data to a screen or monitor of visual display 110 (e.g., responsive to operations of processing unit 102). The terrain data may include, for example, data from a terrain avoidance and warning system, navigation database, traffic and collision avoidance system, and/or any other suitable source of terrain information useful to a pilot or flight crew member. The weather data may include, for example, data from an onboard weather radar system, and/or a component of an external weather data source (e.g., ground-based weather system, satellite-based weather system, etc.). For this embodiment, a graphics processor of visual display 110 (e.g., responsive to operations of processing unit 102) may render a multi-colored image of absolute terrain data and aircraft-relative terrain data on a screen of visual display 110, along with relevant navigation information (e.g., suitable symbols representing locations of VORs, airports, airways, etc.). The graphics processor (e.g., responsive to operations of processing unit 102) may also render respective multi-colored images of weather data on the screen of visual display 110. In accordance with the principles of the present invention, the weather data and relative terrain data may be overlaid on top of the absolute terrain data on the screen of visual display 110.

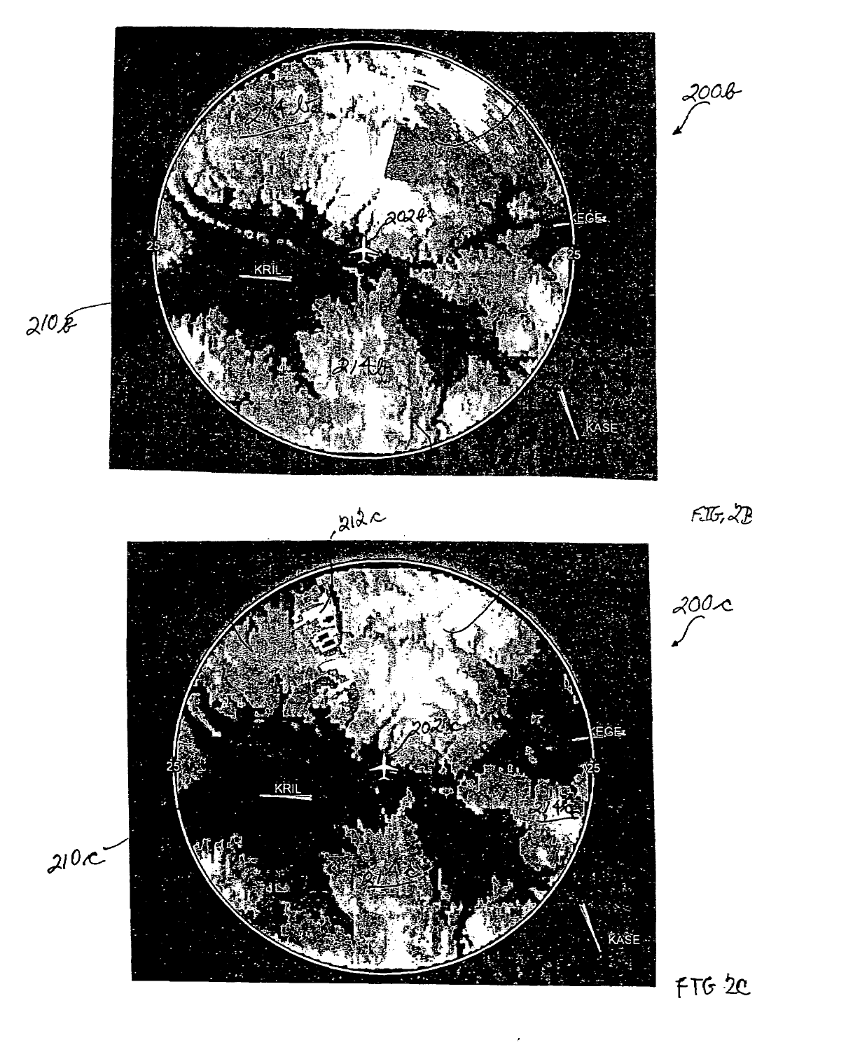

Responsive to operations of processing unit 102, the graphics processor of visual display 110 can render multi-colored symbols to be shown on the screen of visual display 110 that represent, for example, locations and areas of weather cells, locations of terrain that may be threats to the aircraft, and locations of obstacles (e.g., other aircraft, buildings, radio antennas, etc.) that may be threats to the aircraft. Thus, visual display 110 can simultaneously show potential terrain and weather threats in various colors depending on the level of the threat(s) imposed. For example, visual display 110 can show potential terrain and weather threats in red for warning (e.g., immediate danger), yellow for caution (e.g., possible danger), and green for safety (e.g., terrain and/or weather that is not a threat to the aircraft). Notably, in this regard, FIGS. 2A-2C are related pictorial representations depicting visual displays that illustrate one or more exemplary embodiments of the present invention.

Referring to FIG. 2A, a pictorial representation of a visual display 200a (e.g., presentation for visual display 110 in FIG. 1) is shown, which includes a visual representation of an aircraft 202a, a plurality of visual representations of airports 204a, 206a, 208a, and a visual representation of absolute (e.g., relative to mean sea level) terrain elevation information (indicated generally as 210a) painted, for this illustrative example, within a circle having a 25 mile radius extending from the position of aircraft 202a. For this example, the absolute terrain information 210a is painted with a typical absolute terrain elevation color of brown. Notably, no aircraft-relative terrain elevation information is being shown on visual display 200a. However, in accordance with the principles of the present invention, a visual representation of weather radar information (e.g., indicated generally as 212a) is being shown on visual display 200a. For this illustrative example, it may be assumed that the weather radar information 212a being displayed has a relatively large dwell time or persistence of about 95-100% (e.g., a pilot has set rotatable knob 112 associated with control unit 108 at or close to a mechanical upper limit).

FIG. 2B shows a pictorial representation of a visual display 200b (e.g., presentation for visual display 110 in FIG. 1), which further illustrates the principles of the present invention. For example, similar to FIG. 2A, visual display 200b includes a visual representation of an aircraft 202b, a plurality of visual representations of airports 204b, 206b, 208b, and a visual representation of absolute (e.g., relative to mean sea level) terrain elevation information (indicated generally by grayscale as 210b) painted within a circle having a 25 mile radius extending from the position of aircraft 202b. Similar to the example shown in FIG. 2A, for illustrative purposes, weather radar information (e.g., indicated generally as 212b) is being shown on visual display 200b. However, FIGS. 2A and 2B differ in that relative terrain information (e.g., indicated generally as 214b) is now being posted in visual display 200b (e.g., aircraft 202b may be descending in altitude). Also, in accordance with the principles of the present invention, for this illustrative example, it may be assumed that the weather radar information 212b being displayed has a medium dwell time or persistence of about 50% (e.g., a pilot has set the rotatable knob 112 associated with control unit 108 halfway between the knob's mechanical limits). Thus, the pilot has controlled the length of time that the weather data is being displayed (e.g., its persistence), which effectively reduces and/or eliminates confusion in visualizing the terrain data and weather data being displayed simultaneously on the integrated, multi-color visual display 200b.

FIG. 2C shows a pictorial representation of a visual display 200c (e.g., presentation for visual display 110 in FIG. 1), which further illustrates the principles of the present invention. For example, similar to FIG. 2B, visual display 200c includes a visual representation of an aircraft 202c, a plurality of visual representations of airports 204c, 206c, 208c, and a visual representation of absolute (e.g., relative to mean sea level) terrain elevation information (indicated generally by grayscale as 210c) painted within a circle having a 25 mile radius extending from the position of aircraft 202c. Similar to the example shown in FIG. 2B, for illustrative purposes, weather radar information (e.g., indicated generally as 212c) is being shown on visual display 200c. Also, similar to FIG. 2B, relative terrain information (e.g., indicated generally as 214c) is being posted in visual display 200c (e.g., aircraft 202c may still be descending in altitude). However, in accordance with the principles of the present invention, FIGS. 2B and 2C differ in that it may now be assumed that the weather radar information 212c being displayed has a relatively small dwell time or persistence of about 5-10% (e.g., a pilot has set the rotatable knob 112 associated with control unit 108 near to the knob's lower mechanical limit). Thus, the pilot has further controlled the length of time that the weather data is being displayed (e.g., its persistence) to that of a very thin sweep, which further reduces and/or eliminates confusion in visualizing the terrain data and weather data being displayed simultaneously on the integrated, multi-color visual display 200c.

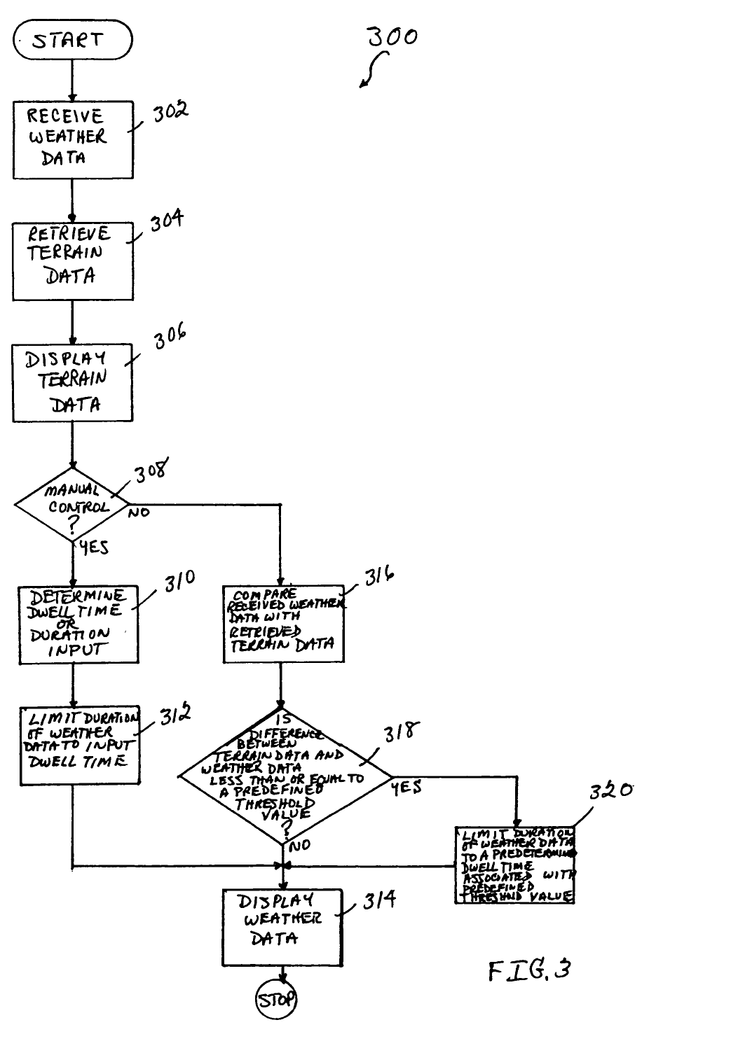

FIG. 3 depicts a flow chart showing an exemplary method 300 for eliminating pilot confusion resulting from a simultaneous showing of terrain data and weather data on an integrated, multi-color aircraft display, in accordance with one or more embodiments of the present invention (e.g., as illustrated by the pictorial representations shown in FIGS. 2A-2C). Referring to FIGS. 1 and 3, for this example, processing unit 102 receives weather information from weather data source 106 (step 302). Processing unit 102 then retrieves absolute terrain information and relative terrain information (e.g., associated with the aircraft's position), if any, from database 104 (step 304). For example, the absolute terrain information and relative terrain information to be retrieved may be determined by the current position and/or altitude of the aircraft (e.g., provided by a conventional position sensing device). Next, processing unit 102 generates visual display control signals to color code (e.g., brown) the retrieved absolute terrain information and (e.g., green, yellow and/or red) the retrieved relative terrain information, if any, and sends the visual display control signals for the color coded absolute terrain information and relative terrain information, if any, to visual display 110 (step 306). Processing unit 102 then determines whether or not manual control of the dwell time or duration of the weather information has been selected (step 308). For example, a pilot or other flight crew member may elect to manually control the weather radar dwell time or duration (e.g., by rotating knob 112 or keying in control symbols with keyboard 114), or alternatively, the pilot or other flight crew member may elect to have the weather radar dwell time or duration automatically controlled (e.g., by a suitable algorithm executed in software by processing unit 102).

If (at step 308), processing unit 102 determines that manual control of the dwell time or duration of the weather information has been selected, then processing unit 102 determines what dwell time or duration has been input (step 310). For example, processing unit 102 can determine the position of rotatable knob 112. Processing unit 102 then limits the dwell time or duration of the received weather information in accordance with the input dwell time or duration (step 312). Next, processing unit 102 generates visual display control signals to color code (e.g., green, yellow and/or red) the limited weather information, and sends the visual display control signals for the color coded, limited weather information to visual display 110 (step 314).

Returning to step 308, if processing unit 102 determines that manual control of the dwell time or duration of the weather information has not been selected (e.g., automatic control of the dwell time or duration has been selected), then processing unit 102 executes a suitable algorithm that compares a quantification of the received weather information (e.g., weather data covering a certain square mile area) with a quantification of the retrieved absolute terrain information and/or relative terrain information (e.g., terrain data covering a certain square mile area) (step 316). From this comparison of the quantification of the received weather information and the quantification of the retrieved absolute terrain information and/or relative terrain information, processing unit 102 then determines whether a quantified difference between the weather information and the terrain information is less than or equal to a predefined threshold value (e.g., predetermined square mile area) (step 318). If so, then processing unit 102 limits the dwell time or duration of the received weather information to a predetermined value associated with the predefined threshold value (step 320). Otherwise, if (at step 318) processing unit 102 determines that the quantified difference between the weather information and the terrain information is not less than or equal to the predefined threshold value, then processing unit 102 generates visual display control signals to color code (e.g., green, yellow and/or red) the received weather information, and sends the visual display control signals for the color coded weather information to visual display 110 (step 314).

It is important to note that while the present invention has been described in the context of a fully functioning aircraft display system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular aircraft display system.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

1. A system for eliminating confusion between weather data and terrain data in a visual display, comprising:
a weather data source operable to generate weather data;
a data storage unit, said data storage unit operable to store at least one of absolute terrain data and relative terrain data;
a processing unit coupled to said weather data source and said data storage unit, said processing unit operable to:
receive said weather data;
retrieve said at least one of said absolute terrain data and said relative terrain data, and
overlay at least a portion of said weather data on said at least one of said absolute terrain data and said relative terrain data; and
a display unit coupled to said processing unit, said display unit operable to display said at least one of said absolute terrain data and said relative terrain data, and display said overlaid weather data in a display sweep.

2. The system of claim 25, wherein said time duration is determined by a manual input device or is automatically determined.

3-4. (canceled)

5. The system of claim 1, wherein said weather data source comprises a weather radar system.

6. The system of claim 1, wherein said weather data source comprises an external weather system.

7. The system of claim 1, wherein said weather data source comprises a weather sensor.

8. The system of claim 1, wherein said weather data source comprises a database.

9. The system of claim 1, wherein said data storage unit comprises a terrain database.

10. The system of claim 1, wherein said data storage unit includes data received from a sensor.

11. The system of claim 1, wherein said control unit comprises a rotatable device coupled to an electronic circuit.

12-13. (canceled)

14. A method for eliminating confusion between weather data and terrain data in a visual display, comprising the steps of:
receiving weather data;
retrieving terrain data;
displaying said retrieved terrain data; and
overlaying at least a portion of said weather data on said terrain data in a display sweep.

15. The method of claim 14, wherein a time duration of said display sweep is determined by a manual input device.

16. The method of claim 14, wherein a time duration of said sweep is determined automatically.

17. (canceled)

18. The method of claim 14, wherein the receiving step further comprises receiving said weather data from a weather radar system.

19. The method of claim 14, wherein the receiving step further comprises receiving said weather data from an external weather system.

20. The method of claim 14, wherein the retrieving step further comprises retrieving said terrain data from a terrain database.

21. (canceled)

22. A computer program product, comprising:
a computer-usable medium having computer-readable code embodied therein for configuring a computer processor, the computer program product comprising:
a first executable computer-readable code configured to cause a computer processor to receive weather data;
a second executable computer-readable code configured to cause the computer processor to retrieve terrain data elements;
a third executable computer-readable code configured to cause the computer processor to display said retrieved terrain data;
a fourth executable computer-readable code configured to cause the computer processor to overlay at least a portion of said weather data on said retrieved terrain data; and
a fifth executable computer-readable code configured to cause the computer processor to display said overlaid weather data in a display sweep.

23. The computer program product of claim 22, further comprising:
a sixth executable computer-readable code configured to cause the computer processor to determine a time duration for said display sweep.

24. The computer program product of claim 23, further comprising:
a seventh executable computer-readable code configured to cause the computer processor to determine a dwell time for said overlaid weather data.

25. The system of claim 1, further comprising a control unit coupled to said processing unit, said control unit operable to control a time duration of said display sweep.

26. The system of claim 25, wherein said control unit is further operable to control a dwell of said overlaid weather data.

27. A system for eliminating confusion between weather data and terrain data in a visual display, comprising:
means for receiving weather data from a weather data source;
means for retrieving terrain data; and
means for overlaying at least a portion of said weather data on said terrain data in a display sweep.

28. The system of claim 27, further comprising means for displaying said display sweep.

29. The system of claim 27, further comprising means for determining a percentage of display for said display sweep.
